(19) United States
(12) Patent Application Publication
(10) Pub. No.: US 2008/0030097 A1
(43) Pub. Date: Feb. 7, 2008

(54) WEDGE MODIFICATION AND DESIGN FOR MAINTAINING ROTOR COIL SLOT IN A GENERATOR

(76) Inventor: Michael J. Bresney, Altamont, NY (US)

Correspondence Address: Michael F. Hoffman, 14th Floor, 75 State Street, Albany, NY, 12207, US

(21) Appl. No.: 11/687,394

(22) Filed: Mar. 16, 2007

Related U.S. Application Data
(60) Provisional application No. 60/804,846, filed on Jun. 15, 2006.

(51) Int. Cl. H02K 3/48

(52) U.S. Cl. 310/214

(57) ABSTRACT

A rotor coil wedge for a rotor coil slot in a generator rotor. The rotor coil wedge has a generally dove tail cross-section for placement in the rotor coil slot, and includes: an end surface; a side surface; and a beveled edge where the end surface meets the side surface.

This patent application claims priority of co-pending provisional patent application serial number U.S. 60/804,846, filed on Jun. 15, 2006, entitled “WEDGE MODIFICATION AND DESIGN FOR MAINTAINING ROTOR COIL SLOT IN A GENERATOR,” the contents of which is hereby incorporation by reference.

### FIELD OF THE INVENTION

The invention relates generally maintaining generators, and more particularly to an improved wedge design and wedge modification as a preventive action against fretting and cracking in the rotor coil slot region of a generator.

### BACKGROUND OF THE INVENTION

Conventional dynamoelectric machines, such as generators used with gas and steam turbines, employ forged rotors of magnetic material into which radial slots are machined for receiving the conductive turns of field windings which are interconnected such as to produce a desired magnetic flux pattern. Typically, included in such conventional rotor slots are creepage blocks at both the top and bottom ends of the slot as well as coil slot wedges for resisting the radially outward forces exerted on the windings when the rotor is operational.

The slot wedges, which are shaped to fit into a generally dovetail shaped region of the generator field, are used to maintain the copper coils in place while the rotor is spinning at, for example, 3600 revolutions per minute. In a typical embodiment, such coil slot wedges are normally 6 to 12 inches long with a number of such wedges being required for each coil slot, particularly in the longer rotors with high electrical ratings. Unfortunately, such configurations are known to cause cracking in the radial slot walls of the generator, at the butt joint between adjacent rotor wedges, apparently due to fretting damage found at the ends of steel wedges. If allowed to remain in the rotor, these cracks can grow and potentially cause a catastrophic failure of the rotor.

Various approaches have been utilized to reduce and/or address this problem, including repairing cracked generator rotor teeth by removing the damaged rotor tooth material; using aluminum rotor wedges; and machining away the damaged tooth material and to replace the multiple original short steel rotor pole wedges with a single, full-length aluminum wedge.

U.S. Pat. No. 6,849,972, entitled Generator Rotor Fretting Fatigue Crack Repair, issued to Barnes et al., on Feb. 1, 2005, which is hereby incorporated by reference, discloses a method of repairing a crack in at least one side of a dovetail portion of a generator rotor coil slot wall by (a) machining a groove at least partly along the inwardly tapered surface to remove damaged material from the coil slot wall; and (b) replacing the axially adjacent steel wedges. Unfortunately, this process requires the generator rotor coil slot wall to be machined, which is both time consuming and invasive.

### SUMMARY OF THE INVENTION

The present invention addresses the above-mentioned problems, as well as others, by providing a wedge design and wedge modification to reduce fretting and cracking caused by the traditional wedge configurations.

In a first aspect, the invention provides a wedge having a generally dove tail cross-section for placement in a rotor coil slot, comprising: an end surface; a side surface; and a beveled edge where the end surface meets the side surface.

In a second aspect, the invention provides a method for servicing a rotor coil slot, comprising: testing the rotor coil slot for indications of failure; and replacing at least one existing wedge with a replacement wedge that has a beveled edge where an end surface of the replacement wedge meets a side surface of the replacement wedge.

In a third aspect, the invention provides a generator rotor having a rotor coil slot containing a plurality of wedges, wherein each wedge includes a beveled edge where an end surface of a given wedge meets a side surface of the given wedge.

In a fourth aspect, the invention provides method of performing preventive maintenance on a generator rotor, comprising: removing a plurality of rotor coil wedges from a rotor coil slot on the generator rotor; and replacing the plurality of rotor coil wedges with replacement wedges, wherein each of the replacement wedges has a beveled edge where an end surface of the replacement wedge meets a side surface of the replacement wedge.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an improved wedge design in accordance with an embodiment of the present invention.

FIG. 2 depicts a side view of two wedges having beveled corners abutted together in accordance with an embodiment of the present invention.

FIG. 3 depicts a top view of the two wedges abutted together in accordance with an embodiment of the present invention.

FIG. 4 depicts a rotor coil slot.

### DETAILED DESCRIPTION OF THE INVENTION

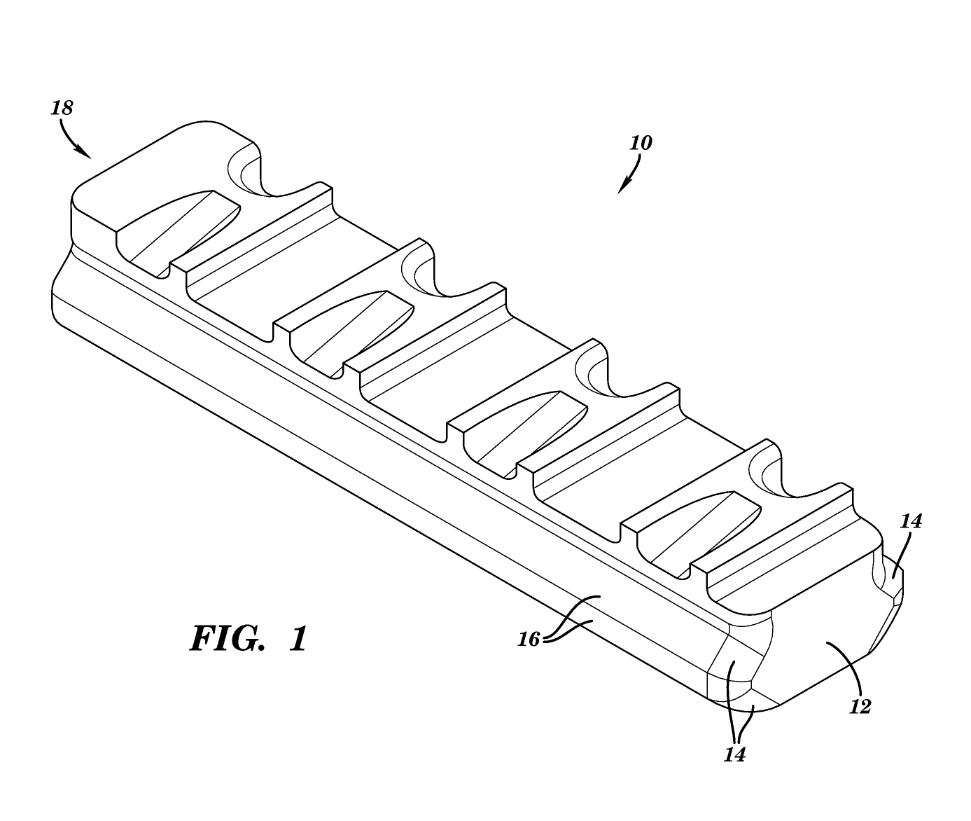

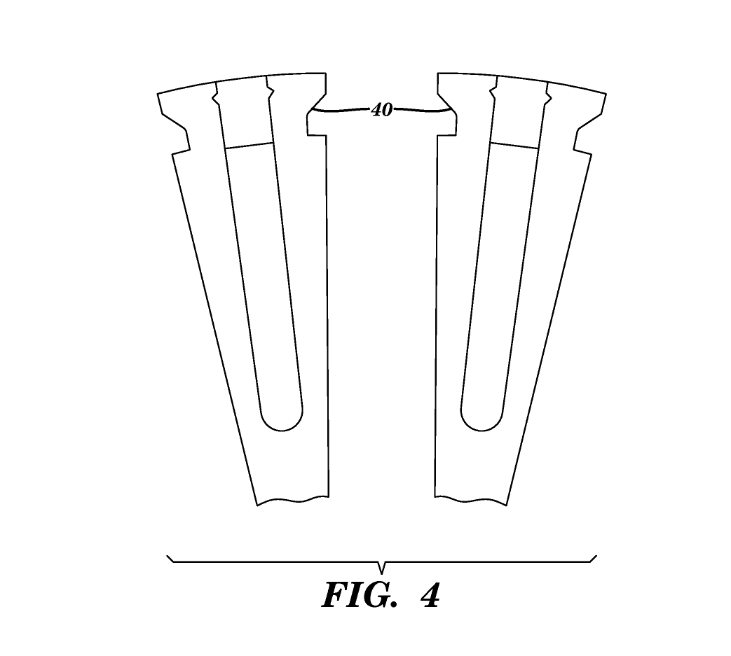

Referring now to drawings, FIG. 1 depicts a generator rotor coil slot wedge (“wedge”) 10 configured for insertion into rotor coil slot 40, such as that shown in FIG. 4. Rotor coil slot 40 is integrated lengthwise into a generator rotor (not shown). As can be seen, wedge 10 comprises a substantially dove tail cross-sectional profile that allows wedge 10 to be slidably secured into the rotor coil slot 40. As noted, in a typical implementation, a series of such wedges 10 are butted end to end such that end surface 12 interfaces with a similar end surface of an adjacent wedge. At the end of each rotor coil slot 40 there is a retaining ring (not shown) to hold the wedges 10 in the rotor coil slot 40.

Wedge 10 is an improvement over existing wedge designs in that it includes a beveled (or radius) edge 14 where the end surface 12 meets the bottom and side surfaces 15,16. Beveling may be done at both end surfaces 12, 18 of the wedge 10. Beveled edge 14 reduces the effective surface area of end surface 12 such that a clearance is created between end surface 12 and the surface of rotor coil slot 40. This configuration significantly reduces wear and fatigue on rotor coil slot 40 at the interface where wedges 10 are butted together.

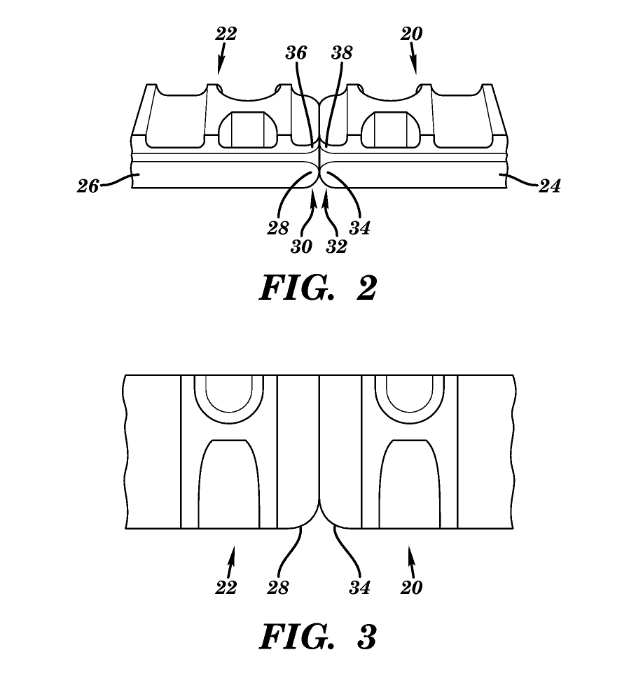

FIG. 2 depicts an isometric side view of two wedges 20, 22 abutted together. As can be seen, top 36, 38, side 28, 34 and bottom 30, 32 beveled regions are created along the beveled edge of each wedge 20, 22. As noted, unlike side surfaces 24, 26, a clearance is created between the beveled regions 36, 38, 28, 24, 30, 32 and the rotor coil slot. (Note that for the purposes of describing the embodiments herein, top beveled regions 36, 38 may be considered part of the side beveled regions 28, 34.)

FIG. 3 depicts a top view of the two wedges 20, 22 abutted together in the rotor coil slot 40. As can be seen, beveled edge regions 28, 34 allow the abutting end surfaces of each wedge to be recessed away from the inner wall of the rotor coil slot 40 to create a clearance.

The wedge configurations described herein having beveled edges can either be manufactured from scratch, or be machined from existing wedges, either for corrective or preventive maintenance. For instance, FIG. 1 depicts a wedge 10 that has been manufactured from scratch to include beveled edges 14. FIGS. 2 and 3 depict wedges 20, 22 that have been modified (i.e., machined) to provide beveled edges where there was previously a straight edge/corner. Note that in the case of FIGS. 2 and 3, only the front sides 24, 26 of the wedges 20, 22 include the beveled feature. However, it is understood that the number and specific placement of the beveled regions implemented on a given wedge may vary depending upon the application. It is also understood that for the purposes of this disclosure, the term “beveled” may include any shape that create a clearance between the interface of two wedges and the rotor coil slot. Thus, for example, while the illustrative embodiments disclosed herein show a rounded bevel or radius, the bevel could be a straight 45 degree cut, a series of straight cuts, etc.

In one illustrative methodology, rotor coil slots and wedges may be serviced as follows. First, perform ultrasonic testing with the wedges in and retaining rings in place using angle beam technology. If indications are found during ultrasonic testing, then remove fretting and cracking in the rotor coil slots with minimal corrective machining to prevent further propagation. Next, replace at least one existing wedge with a replacement wedge that includes a beveled edge to create a clearance to the rotor coil slot forging (i.e., surface) at a wedge to wedge interface. The last step may include: replacing existing wedges with a softer material wedge, such as aluminum, having beveled edges as described above; or machining the existing wedges to add a beveled edge.

In another illustrative embodiment, existing wedges may simply be replaced with replacement wedges having beveled edges are a form of preventive maintenance.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For instance, note that while the embodiments described herein are directed to a generator rotor, the invention could be applied to any application in which wedges are utilized.

1. A wedge having a generally dove tail cross-section for placement in a rotor coil slot, comprising:
an end surface;
a side surface; and
a beveled edge where the end surface meets the side surface.

2. The wedge of claim 1, further comprising:
a bottom surface; and
a second beveled edge where the bottom surface meets the end surface.

3. The wedge of claim 2, further comprising a second side surface having a third beveled edge where the second side surface meets the end surface.

4. The wedge of claim 2, further comprising a second end surface, wherein the second end surface is beveled where the second end surface meets the side surface and bottom surface.

5. A method for servicing a rotor coil slot, comprising:
testing the rotor coil slot for indications of failure; and
replacing at least one existing wedge with a replacement wedge that has a beveled edge where an end surface of the replacement wedge meets a side surface of the replacement wedge.

6. The method of claim 5, wherein the replacement wedge comprises a new wedge.

7. The method of claim 5, wherein the replacement wedge is obtained by machining at least one existing wedge to create the beveled edge.

8. The method of claim 5, wherein the testing includes ultrasonic testing.

9. The method of claim 5, wherein replacement wedge has a second beveled edge where an end surface of the replacement wedge meets a bottom surface of the replacement wedge.

10. A generator rotor having a rotor coil slot containing a plurality of wedges, wherein each wedge includes a beveled edge where an end surface of a given wedge meets a side surface of the given wedge.

11. The generator rotor of claim 10, wherein a first end surface of a first wedge abuts against a second end surface of a second wedge at a wedge interface, and wherein a clearance is created between the wedge interface and a surface of the rotor coil slot.

12. A method of performing preventive maintenance on a generator rotor, comprising:
removing a plurality of rotor coil wedges from a rotor coil slot on the generator rotor; and
replacing the plurality of rotor coil wedges with replacement wedges, wherein each of the replacement wedges has a beveled edge where an end surface of the replacement wedge meets a side surface of the replacement wedge.

13. The method of claim 12, wherein each of the replacement wedges has a second beveled edge where an end surface of the replacement wedge meets a bottom surface of the replacement wedge.

14. The method of claim 12, wherein the replacement wedges are obtained by machining each of the plurality of rotor coil wedges to create the beveled edge.

15. The method of claim 12, wherein the beveled edge creates a clearance between an interface where two replacement wedges abut and the rotor coil slot.
